(19) United States
(12) Patent Application Publication
(10) Pub. No.: US 2012/0201465 A1
(43) Pub. Date: Aug. 9, 2012

(54) IMAGE PROCESSING APPARATUS

(75) Inventor: Hirotaka Hara, Tokyo (JP)

(73) Assignee: OLYMPUS CORPORATION, Tokyo (JP)

(21) Appl. No.: 13/356,797

(22) Filed: Jan. 24, 2012

(30) Foreign Application Priority Data
Feb. 4, 2011 (JP) 2011-022817

(51) Int. Cl. G06K 9/46

(52) U.S. Cl. 382/195

(57) ABSTRACT

An image processing apparatus may include a condition setting unit that sets a specified image capturing time, a specified image capturing location, and specified image capturing composition, an image capturing time determination unit that extracts image data from among a plurality of image data based on additional information included in the image data, an image capturing location determination unit that extracts the image data from among the plurality of image data based on the additional information, a composition determination unit that extracts the image data from among the plurality of image data based on the additional information, and an order setting unit that generates information indicating order of the image data consistent with given conditions based on the additional information for the image data extracted by all of the image capturing time determination unit, the image capturing location determination unit, and the composition determination unit.

### BACKGROUND OF THE INVENTION

1. Field of the Invention

The present invention relates to an image processing apparatus.

Priority is claimed on Japanese Patent Application No. 2011-022817, filed Feb. 4, 2011, the content of which is incorporated herein by reference.

2. Description of the Related Art

All patents, patent applications, patent publications, scientific articles, and the like, which will hereinafter be cited or identified in the present application, will hereby be incorporated by reference in their entirety in order to describe more fully the state of the art to which the present invention pertains.

A method of separating good image data from among a plurality of similar image data continuously captured by one image pickup device is known. Japanese Unexamined Patent Application, First Publication No. 2005-45600 discloses a method of calculating evaluation points for all data of similar images continuously captured by one image pickup device and separating good image data based on the calculated evaluation points.

In addition, recent digital cameras are equipped with a wireless communication function. In these digital cameras, an exchange of image data can be easily performed. In addition, an exchange of image data captured by each person may be performed even when a plurality of persons are imaged by a plurality of image pickup devices from substantially the same location at substantially the same time in substantially the same composition in an imaged scene such as a group photograph. For example, image data may be exchanged between parents even when the parents have taken group photographs of children in a graduation ceremony.

However, when images are captured by the plurality of image pickup devices from substantially the same location at substantially the same time in substantially the same composition, the images of image data are similar to each other. Thus, it is not easy for a user to separate good image data from other image data. For example, it is not easy for the user to separate good image data even when wanting to leave image data in an album by separating one of good image data from among the images captured by the plurality of image pickup devices from substantially the same location at substantially the same time in substantially the same composition.

In addition, although it is possible to separate good image data from among the plurality of similar image data continuously captured by one image pickup device in the method disclosed in Japanese Unexamined Patent Application, First Publication No. 2005-45600, it is not possible to determine image data captured from substantially the same location at substantially the same time in substantially the same composition among a plurality of image data captured by different image pickup devices. Thus, it is not possible to extract similar images from the plurality of image data captured by the plurality of image pickup devices. Accordingly, it is not possible to extract image data captured from substantially the same location at substantially the same time in substantially the same composition from among the plurality of image data captured by the plurality of image pickup devices and automatically separate good image data from extracted image data.

### SUMMARY

The present invention provides an image processing apparatus capable of extracting image data captured from substantially the same location at substantially the same time in substantially the same composition from among a plurality of image data and easily extracting better image data among the extracted image data.

An image processing apparatus may include: a condition setting unit that sets a specified image capturing time, a specified image capturing location, and specified image capturing composition; an image capturing time determination unit that extracts image data that has been captured at the specified image capturing time, which has been set by the condition setting unit, from among a plurality of image data based on additional information included in the image data; an image capturing location determination unit that extracts the image data that has been captured in the specified image capturing location, which has been set by the condition setting unit, from among the plurality of image data based on the additional information; a composition determination unit that extracts the image data that has been captured in the specified image capturing composition, which has been set by the condition setting unit, from among the plurality of image data based on the additional information; and an order setting unit that generates information indicating order of the image data consistent with given conditions based on the additional information for the image data that has been extracted by all of the image capturing time determination unit, the image capturing location determination unit, and the composition determination unit.

The condition setting unit may read, from one specified image data, information indicating an image capturing time of the image data, information indicating an image capturing location of the image data, and information indicating image capturing composition of the image data, set the image capturing time indicated by the information indicating the image capturing time to the specified image capturing time, set the image capturing location indicated by the information indicating the image capturing location to the specified image capturing location, and set the image capturing composition indicated by the information indicating the image capturing composition to the specified image capturing composition.

The condition setting unit may set an image capturing time set by a user to the specified image capturing time, set an image capturing location set by the user to the specified image capturing location, and set image capturing composition set by the user to the specified image capturing composition.

The additional information may be stored in an exchangeable image file format. The additional information may include information indicating a time when an image has been captured, information indicating a location where the image has been captured, and information indicating image capturing composition of the image that includes information indicating a direction of the image, information indicating a length to a subject included in the image, and information indicating a focal length of a lens used when the image has been captured.

The given conditions may be specified by at least one of image capturing condition information and image quality condition information.

The image capturing condition information may indicate at least one of International Organization for Standardization (ISO) sensitivity, an exposure correction amount, a shutter speed, and an open F value of the image data.

The image quality condition information may indicate at least one of an image compression rate and resolution of the image data.

According to the present invention, the condition setting unit sets a specified image capturing time, a specified image capturing location, and specified image capturing composition. In addition, the image capturing time determination unit extracts image data captured at the specified image capturing time set by the condition setting unit from a plurality of image data based on additional information included in the image data. In addition, the image capturing location determination unit extracts image data captured in the specified image capturing location set by the condition setting unit from the plurality of image data based on the additional information. In addition, the composition determination unit extracts image data captured in the specified image capturing composition set by the condition setting unit from the plurality of image data based on the additional information. In addition, the order setting unit generates information indicating order of image data consistent with given conditions based on the additional information for the image data extracted by all of the image capturing time determination unit, the image capturing location determination unit, and the composition determination unit.

Thereby, it is possible to extract image data captured from substantially the same location at substantially the same time in substantially the same composition from among a plurality of image data and extract good image data among the extracted image data.

### BRIEF DESCRIPTION OF THE DRAWINGS

The above features and advantages of the present invention will be more apparent from the following description of certain preferred embodiments taken in conjunction with the accompanying drawings, in which:

FIG. 1 is a block diagram illustrating a configuration of an image processing apparatus in accordance with a first preferred embodiment of the present invention;

FIG. 2 is a flowchart illustrating an operation procedure when the image processing apparatus performs a process of separating a good image in accordance with the first preferred embodiment of the present invention;

FIG. 3 is a flowchart illustrating a processing procedure of an image capturing condition determination unit in accordance with the first preferred embodiment of the present invention; and

FIG. 4 is a flowchart illustrating a processing procedure of an image quality determination unit in accordance with the first preferred embodiment of the present invention.

### DETAILED DESCRIPTION OF THE PREFERRED EMBODIMENTS

The present invention will be now described herein with reference to illustrative preferred embodiments. Those skilled in the art will recognize that many alternative preferred embodiments can be accomplished using the teaching of the present invention and that the present invention is not limited to the preferred embodiments illustrated for explanatory purpose.

Hereinafter, a first preferred embodiment of the present invention will be described with reference to the drawings. In the first preferred embodiment, an image processing apparatus extracts image data captured from substantially the same location at substantially the same time in substantially the same composition from among a plurality of image data captured by a plurality of image pickup devices and extracts good image data among the extracted image data. In the first preferred embodiment, the more image data is consistent with a specified image capturing condition and a specified image quality condition, the better the image data is.

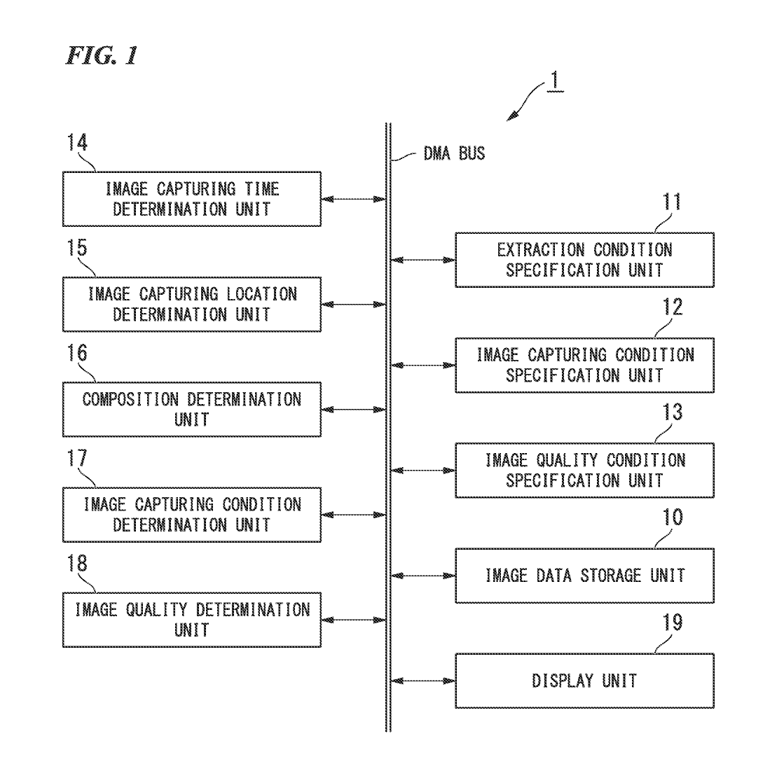

FIG. 1 is a block diagram illustrating a configuration of the image processing apparatus in accordance with the first preferred embodiment of the present invention. In a shown example, the image processing apparatus 1 includes an image data storage unit 10, an extraction condition specification unit 11 (condition setting unit), an image capturing condition specification unit 12, an image quality condition specification unit 13, an image capturing time determination unit 14, an image capturing location determination unit 15, a composition determination unit 16, an image capturing condition determination unit 17 (order setting unit), an image quality determination unit 18 (order setting unit), and a display unit 19. In addition, the parts provided in the image processing apparatus 1 are connected to each other by a direct memory access (DMA) bus.

In the first preferred embodiment, information stored in an exchangeable image file format (Exif) as additional information is included in image data to be processed by the image processing apparatus 1. For example, the additional information in the image data includes information indicating a time when an image has been captured, information indicating a location where the image has been captured (for example, global positioning system (GPS) data indicating a latitude and longitude at which the image has been captured), information indicating a direction of the image, information indicating a focal length to a subject, information indicating a focal length of a lens used when the image has been captured, information indicating a manufacturer name and a model name of an image pickup device capturing the image, information indicating International Organization for Standardization (ISO) sensitivity of the image, information indicating an exposure correction amount of the image, information indicating a shutter speed when the image has been captured, information indicating an open F value of the lens used when the image has been captured, information indicating a photographer capturing the image, information indicating a compression rate of the image, and information indicating resolution of the image.

The image data storage unit 10 stores a plurality of image data captured by a plurality of image pickup devices to be supplied to the image processing apparatus 1. Any method may be used as a method of supplying image data to the image processing apparatus 1. For example, the image data may be transmitted from the image pickup device such as a digital camera to the image processing apparatus 1 using a wireless local area network (LAN). In addition, the image pickup device may be connected to the image processing apparatus 1 via a universal serial bus (USB), and the image data may be transmitted from the image pickup device to the image processing apparatus 1.

The extraction condition specification unit 11 specifies conditions for extracting image data captured from substantially the same location at substantially the same time in substantially the same composition from among a plurality of image data. For example, the extraction condition specification unit 11 specifies conditions of a specified image capturing time, a specified image capturing location, and specified image capturing composition as the conditions for extracting image data captured from substantially the same location at substantially the same time in substantially the same composition. The specified image capturing time is a time when the image has been captured. In addition, the specified image capturing location is a location where the image has been captured. In addition, the specified image capturing composition is image capturing composition of the image defined by the direction of the image (landscape- or portrait-oriented image), the length to the subject, and the focal length of the lens used when the image has been captured.

The extraction condition specification unit 11 may use any method as a method of specifying the conditions for extracting the image data captured from substantially the same location at substantially the same time in substantially the same composition. For example, the user selects one of image data to be extracted as good image data among a plurality of image data stored by the image data storage unit 10. The extraction condition specification unit 11 acquires the information indicating the time when the image has been captured, the information indicating the location where the image has been captured, the information indicating the direction of the image, the information indicating the length to the subject included in the image, and the information indicating the focal length of the lens used when the image has been captured included in image data selected by the user. The extraction condition specification unit 11 may set an image capturing time specified by the information indicating the time when the image has been captured as the specified image capturing time, set an image capturing location specified by the information indicating the location where the image has been captured as the specified image capturing location, and set image capturing composition specified by the information indicating the direction of the image, the information indicating the length to the subject included in the image, and the information indicating the focal length of the lens used when the image has been captured as the specified image capturing composition.

In addition, for example, the extraction condition specification unit 11 may receive the information indicating the specified image capturing time, the information indicating the specified image capturing location, and the information indicating the specified image capturing composition input from the user, and specify conditions of the specified image capturing time, the specified image capturing location, and the specified image capturing composition based on the input information.

The image capturing condition specification unit 12 sets image capturing conditions when a good image is separated based on the image capturing conditions input from the user. The user inputs his/her favorite image capturing conditions to the image capturing condition specification unit 12. For example, the image capturing condition specification unit 12 sets 6 image capturing conditions of “Image capturing by Model X of Manufacturer A,” “ISO Sensitivity 100,” “Exposure Correction Amount+1,” “Shutter Speed 1/1000 Sec,” “Open F Value 1.8 of Lens Used for Image capturing,” and “Image capturing by Photographer Z” as the image conditions when the good image is separated based on the user's input.

In addition, the image capturing condition specification unit 12 specifies preferential order of image capturing conditions based on preferential order of the image capturing conditions input from the user. The user inputs the preferential order of his/her favorite image capturing conditions to the image capturing condition specification unit 12. For example, the image capturing condition specification unit 12 specifies that preference 1 is “Image capturing by Model X of Manufacturer A,” preference 2 is “ISO Sensitivity 100,” preference 3 is “Exposure Correction Amount+1,” preference 4 is “Shutter Speed 1/1000 Sec,” preference 5 is “Open F Value 1.8 of Lens Used for Image capturing,” and preference 6 is “Image capturing by Photographer Z” in the preferential order of the image capturing conditions when the good image is separated based on the user's input. Preference 1 is highest and the preferential order decreases in order from preference 1 to preference 6.

The image capturing condition specification unit 12 may set image capturing conditions and preferential order of the image capturing conditions pre-stored in a condition storage unit (not shown) without setting the image capturing conditions and the preferential order of the image capturing conditions when the good image is separated based on the input from the user.

The image quality condition specification unit 13 sets image quality conditions when the good image is separated based on image quality conditions input from the user. The user inputs his/her favorite image quality conditions to the image quality condition specification unit 13. For example, the image quality condition specification unit 13 sets two image quality conditions of “Image Compression Rate 80% or Higher” and “Resolution 3264×2448 or Higher” based on the user's input. In addition, the image quality condition specification unit 13 specifies the preferential order of the image quality conditions based on the preferential order of the image quality conditions input from the user. The user inputs preferential order of his/her favorite image quality conditions to the image quality condition specification unit 13. For example, the image quality condition specification unit 13 specifies that preference 1 is “Image Compression Rate 80% or Higher” and preference 2 is “Resolution 3264×2448 or Higher” in the preferential order of the image quality conditions when the good image is separated based on the user's input.

The image quality condition specification unit 13 may set image quality conditions and preferential order of the image quality conditions pre-stored in a condition storage unit (not shown) without setting the image quality conditions and the preferential order of the image quality conditions when the good image is separated based on the input from the user.

The image capturing time determination unit 14 specifies a time when an image has been captured by reading the information indicating the time when the image has been captured included in image data, and extracts image data captured at the specified image capturing time specified by the extraction condition specification unit 11 from among a plurality of image data. Because image capturing can be considered as that at substantially the same time even when the image capturing time is slightly different, the image capturing time determination unit 14 may also extract image data captured from a time that is earlier than the specified image capturing time by a given time to a time that is later than the specified image capturing time by a given time. The given time may be predefined or may be arbitrarily set by the user.

The image capturing location determination unit 15 specifies a location where an image has been captured by reading the information indicating the location where the image has been captured included in image data, and extracts image data captured in the specified image capturing location specified by the extraction condition specification unit 11 from among a plurality of image data. Because image capturing can be considered as that in substantially the same location even when the image capturing location is slightly different, the image capturing location determination unit 15 may also extract image data captured in a location separated from the specified image capturing location by a given distance. The given distance may be predefined or may be arbitrarily set by the user.

The composition determination unit 16 specifies image capturing composition of an image by reading the information indicating the image capturing composition of the image included in image data, and extracts image data of the specified image capturing composition specified by the extraction condition specification unit 11 from among a plurality of image data. Because an image can be considered as that of substantially the same composition even when the image capturing composition is slightly different, the image capturing location determination unit 15 may also extract image data of image capturing composition that is only different from the specified image capturing composition in a given condition. The given condition may be predefined or may be arbitrarily set by the user.

The image capturing condition determination unit 17 reads information indicating image capturing conditions of an image included in image data, and sets a value indicating order of good image data for a plurality of images based on the image capturing conditions and the preferential order of the image capturing conditions specified by the image capturing condition specification unit 12. A detailed operation procedure of the image capturing condition determination unit 17 will be described later.

The image quality determination unit 18 reads information indicating image quality conditions of an image included in the image data, and sets a value indicating order of good image data for a plurality of image data based on the image quality conditions and the preferential order of the image quality conditions specified by the image quality condition specification unit 13. A detailed operation procedure of the image quality determination unit 18 will be described later.

The display unit 19 is a display device such as a liquid crystal display that displays image data, captured from substantially the same location at substantially the same time in substantially the same composition, extracted from a plurality of image data captured by a plurality of image pickup devices in order of good image data.

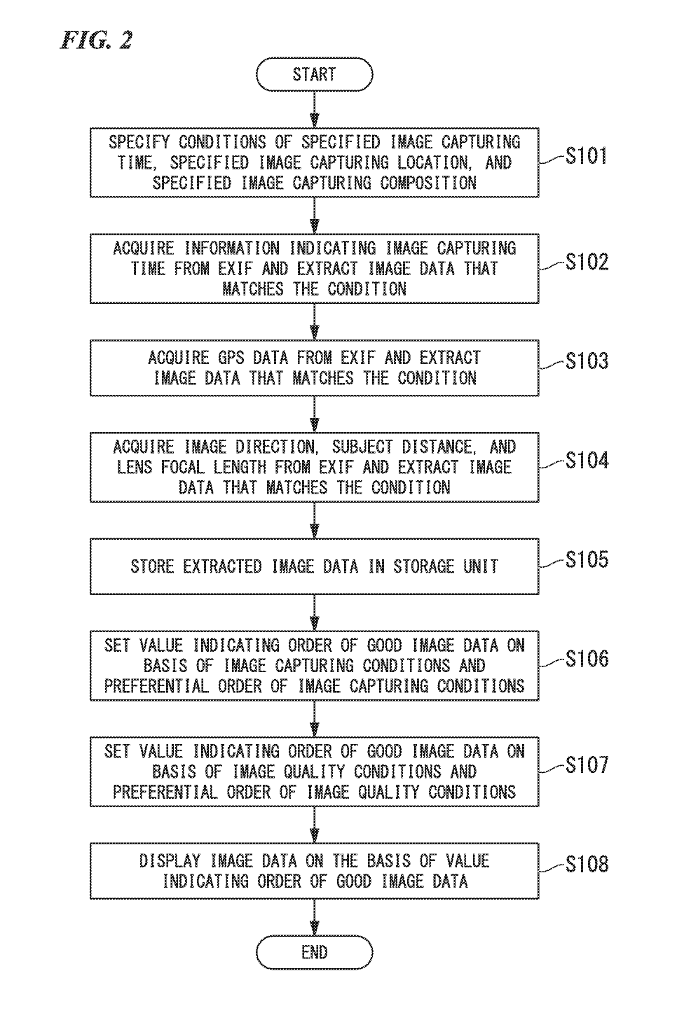

Next, an operation procedure when the image processing apparatus 1 performs a process of separating a good image will be described. FIG. 2 is a flowchart illustrating an operation procedure when the image processing apparatus 1 performs the process of separating a good image in accordance with the first preferred embodiment. When the image processing apparatus 1 initiates the process of separating a good image, a plurality of image data captured by a plurality of image pickup devices are stored in the image data storage unit 10.

### (Step S101)

The extraction condition specification unit 11 specifies conditions of a specified image capturing time, a specified image capturing location, and specified image capturing composition as conditions for extracting image data captured from substantially the same location at substantially the same time in substantially the same composition. Thereafter, it proceeds to the process of step S102.

### (Step S102)

The image capturing time determination unit 14 specifies a time when an image has been captured by reading information indicating the time when the image has been captured included in Exif of the image data for all the image data stored by the image data storage unit 10. The image capturing time determination unit 14 extracts image data captured at the same time as the specified image capturing time specified by the extraction condition specification unit 11 in the process of step S101 from among all the image data stored by the image data storage unit 10. Thereafter, it proceeds to the process of step S103.

### (Step S103)

The image capturing location determination unit 15 specifies a location where the image has been captured by reading information (GPS data) indicating the location where the image has been captured included in Exif of the image data for each of the image data extracted by the image capturing time determination unit 14 in the process of step S102. The image capturing location determination unit 15 extracts image data captured in the same location as the specified image capturing location specified by the extraction condition specification unit 11 in the process of step S101 from among the image data extracted by the image capturing time determination unit 14 in the process of step S102. Thereafter, it proceeds to the process of step S104.

### (Step S104)

The composition determination unit 16 specifies image capturing composition of the image by reading information indicating a direction of the image (landscape- or portrait-oriented image), information indicating a length to a subject, and information indicating a focal length of a lens used when the image has been captured included in Exif of the image data for each of the image data extracted by the image capturing location determination unit 15 in the process of step S103. The composition determination unit 16 extracts image data captured in the same composition as the specified image capturing composition specified by the extraction condition specification unit 11 in the process of step S101 from among the image data extracted by the image capturing location determination unit 15 in the process of step S103. Thereafter, it proceeds to the process of step S105.

### (Step S105)

The image data storage unit 10 stores the image data extracted by the composition determination unit 16 in the process of step S104. Thereafter, it proceeds to the process of step S106.

### (Step S106)

The image capturing condition specification unit 12 sets image capturing conditions and preferential order of the image capturing conditions when a good image is separated. The image capturing condition determination unit 17 reads information indicating a manufacturer name and a model name of an image pickup device capturing the image, information indicating ISO sensitivity of the image, information indicating an exposure correction amount of the image, information indicating a shutter speed when the image has been captured, information indicating an open F value of the lens used when the image has been captured, and information indicating a photographer capturing the image included in Exif of the image data for all the image data stored by the image data storage unit 10 in the process of step S105. The image capturing condition determination unit 17 sets a value indicating order of good image data for the image data stored by the image data storage unit 10 in the process of step S105 based on the image capturing conditions and the preferential order of the image capturing conditions set by the image capturing condition specification unit 12. Thereafter, it proceeds to the process of step S107. A detailed processing procedure of step S106 will be described later. In the first preferred embodiment, it is indicated that the smaller the value indicating the order of good image data, the better the image data.

### (Step S107)

The image quality condition specification unit 13 sets image quality conditions and preferential order of the image quality conditions when a good image is separated. The image quality determination unit 18 reads information indicating a compression rate of the image and information indicating resolution of the image included in Exif of the image data for the image data stored by the image data storage unit 10 in the process of step S105. The image quality determination unit 18 sets the value indicating the order of good image data for the image data stored by the image data storage unit 10 in the process of step S105 based on the image quality conditions and the preferential order of the image quality conditions specified by the image quality condition specification unit 13. Thereafter, it proceeds to the process of step S108. A detailed processing procedure of step S107 will be described later.

### (Step S108)

The display unit 19 displays the image data stored by the image data storage unit 10 in the process of step S105 from the top to the bottom of the screen in order from image data having a small value indicating the order of good image data to image data having a large value indicating the order of good image data based on the value indicating the order of good image data set in steps S106 and S107. Thereafter, the process ends. A method in which the display unit 19 displays image data is not limited thereto. For example, the display unit 19 may display images of the image data stored by the image data storage unit 10 in the process of step S105 one by one in order from the image data having a small value indicating the order of good image data to the image data having a large value indicating the order of good image data set in steps S106 and S107.

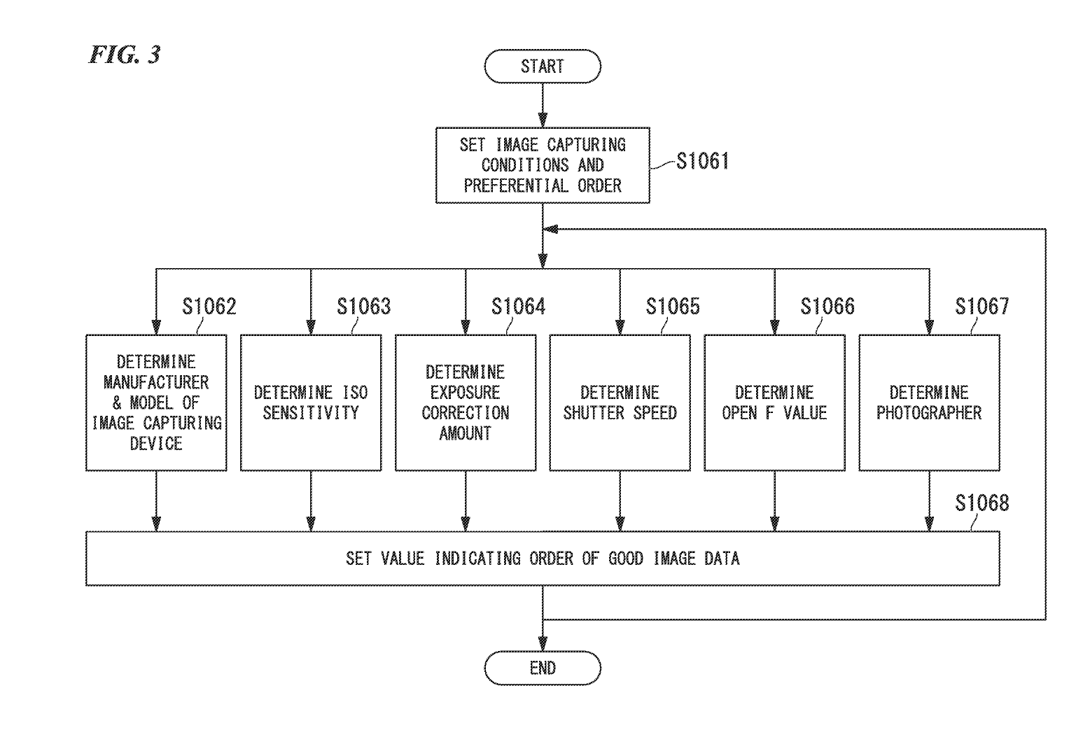

Next, a detailed processing procedure of the process of step S106 will be described. FIG. 3 is a flowchart illustrating the detailed processing procedure of the process of step S106 in accordance with the first preferred embodiment.

### (Step S1061)

The image capturing condition specification unit 12 sets image capturing conditions and preferential order of the image capturing conditions when a good image is separated. Thereafter, the image capturing condition determination unit 17 executes the process of steps S1062 to S1067 based on the image capturing conditions and the preferential order of the image capturing conditions set by the image capturing condition specification unit 12.

Hereinafter, a description will be given of an example in which an image capturing condition of preference 1 is “Image capturing by Model X of Manufacturer A,” an image capturing condition of preference 2 is “ISO Sensitivity 100,” an image capturing condition of preference 3 is “Exposure Correction Amount+1,” an image capturing condition of preference 4 is “Shutter Speed 1/1000 Sec,” an image capturing condition of preference 5 is “Open F Value 1.8 of Lens Used for Image capturing,” and an image capturing condition of preference 6 is “Image capturing by Photographer Z” as the image capturing conditions and the preferential order of the image capturing conditions set by the image capturing condition specification unit 12.

In this case, the image capturing condition determination unit 17 first sets a value indicating order of good image data for the image data based on “Image capturing by Model X of Manufacturer A” that is the image capturing condition of preference 1 (steps S1062 and S1068). Subsequently, the image capturing condition determination unit 17 sets the value indicating the order of good image data for the image data based on “ISO Sensitivity 100” that is the image capturing condition of preference 2 (steps S1063 and S1068). Subsequently, the image capturing condition determination unit 17 sets the value indicating the order of good image data for the image data based on “Exposure Correction Amount+1” that is the image capturing condition of preference 3 (steps S1064 and S1068). Subsequently, the image capturing condition determination unit 17 sets the value indicating the order of good image data for the image data based on “Shutter Speed 1/1000 Sec” that is the image capturing condition of preference 4 (steps S1065 and S1068). Subsequently, the image capturing condition determination unit 17 sets the value indicating the order of good image data for the image data based on “Open F Value 1.8 of Lens Used for Image capturing” that is the image capturing condition of preference 5 (steps S1066 and S1068). Subsequently, the image capturing condition determination unit 17 sets the value indicating the order of good image data for the image data based on “Image capturing by Photographer Z” that is the image capturing condition of preference 6 (steps S1067 and S1068). That is, the image capturing condition determination unit 17 performs the process in the order of Step S1062→Step S1068→Step S1063→Step S1068→Step S1064→Step S1068→Step S1065→Step S1068→Step S1066→Step S1068→Step S1067→Step S1068.

### (Step S1062)

The image capturing condition determination unit 17 reads information indicating a manufacturer name and a model name of an image pickup device capturing an image included in Exif of the image data from each of the image data stored by the image data storage unit 10 in the process of step S105. Thereafter, it proceeds to the process of step S1068.

Based on the information indicating the manufacturer name and the model name of the image pickup device capturing the image read in the process of step S1062, the image capturing condition determination unit 17 sets a value of a first high-order digit within the value indicating the order of good image data to “1” for image data of “Image capturing by Model X of Manufacturer A” among the image data stored by the image data storage unit 10 in the process of step S105, and sets the value of the first high-order digit within the value indicating the order of good image data to “2” for the other image data. Thereafter, it proceeds to the process of step S1063.

### (Step S1063)

The image capturing condition determination unit 17 reads information indicating ISO sensitivity of the image included in Exif of the image data from each of the image data stored by the image data storage unit 10 in the process of step S105. Thereafter, it proceeds to the process of step S1068.

### (Step S1068)

Based on the information indicating the ISO sensitivity of the image read in the process of step S1063, the image capturing condition determination unit 17 sets a value of a second high-order digit within the value indicating the order of good image data to “1” for image data of “ISO Sensitivity 100” among the image data stored by the image data storage unit 10 in the process of step S105, and sets the value of the second high-order digit within the value indicating the order of good image data to “2” for the other image data. Thereafter, it proceeds to the process of step S1064.

### (Step S1064)

The image capturing condition determination unit 17 reads information indicating an exposure correction amount of the image included in Exif of the image data from each of the image data stored by the image data storage unit 10 in the process of step S105. Thereafter, it proceeds to the process of step S1068.

### (Step S1068)

Based on the information indicating the exposure correction amount of the image read in the process of step S1064, the image capturing condition determination unit 17 sets a value of a third high-order digit within the value indicating the order of good image data to “1” for image data of “Exposure Correction Amount+1” among the image data stored by the image data storage unit 10 in the process of step S105, and sets the value of the third high-order digit within the value indicating the order of good image data to “2” for the other image data. Thereafter, it proceeds to the process of step S1065.

### (Step S1065)

The image capturing condition determination unit 17 reads information indicating a shutter speed when the image has been captured included in Exif of the image data from each of the image data stored by the image data storage unit 10 in the process of step S105. Thereafter, it proceeds to the process of step S1068.

### (Step S1068)

Based on the information indicating the shutter speed when the image has been captured read in the process of step S1065, the image capturing condition determination unit 17 sets a value of a fourth high-order digit within the value indicating the order of good image data to “1” for image data of “Shutter Speed 1/1000 Sec” among the image data stored by the image data storage unit 10 in the process of step S105, and sets the value of the fourth high-order digit within the value indicating the order of good image data to “2” for the other image data. Thereafter, it proceeds to the process of step S1066.

### (Step S1066)

The image capturing condition determination unit 17 reads information indicating a focal length of a lens used when the image has been captured included in Exif of the image data from each of the image data stored by the image data storage unit 10 in the process of step S105. Thereafter, it proceeds to the process of step S1068.

### (Step S1068)

Based on the information indicating the focal length of the lens used when the image has been captured read in the process of step S1066, the image capturing condition determination unit 17 sets a value of a fifth high-order digit within the value indicating the order of good image data to “1” for image data of “Open F Value 1.8 of Lens Used for Image capturing” among the image data stored by the image data storage unit 10 in the process of step S105, and sets the value of the fifth high-order digit within the value indicating the order of good image data to “2” for the other image data. Thereafter, it proceeds to the process of step S1067.

### (Step S1067)

The image capturing condition determination unit 17 reads information indicating a photographer capturing the image included in Exif of the image data from each of the image data stored by the image data storage unit 10 in the process of step S105. Thereafter, it proceeds to the process of step S1068.

### (Step S1068)

Based on the information indicating the photographer capturing the image read in the process of step S1067, the image capturing condition determination unit 17 sets a value of a sixth high-order digit within the value indicating the order of good image data to “1” for image data of “Image capturing by Photographer Z” among the image data stored by the image data storage unit 10 in the process of step S105, and sets the value of the sixth high-order digit within the value indicating the order of good image data to “2” for the other image data. Thereafter, it proceeds to the process of step S107 shown in FIG. 2.

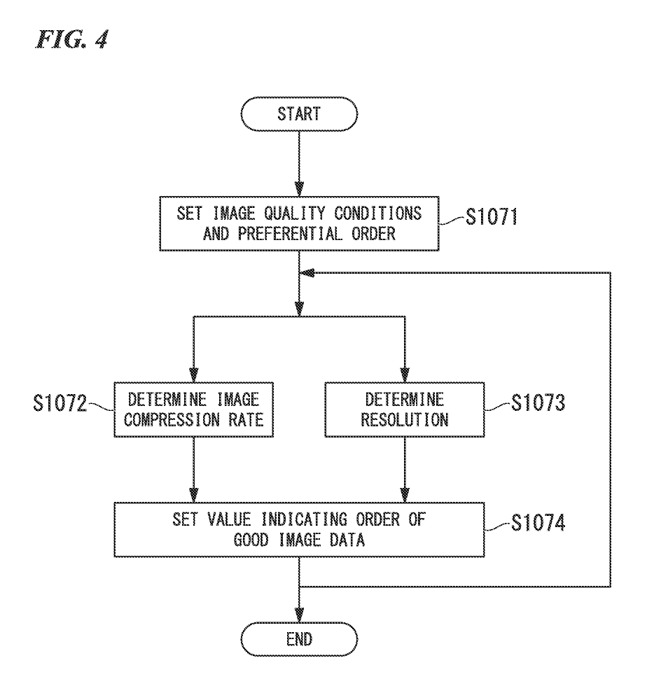

Next, a detailed processing procedure of the process of step S107 will be described. FIG. 4 is a flowchart illustrating the detailed processing procedure of the process of step S107 in accordance with the first preferred embodiment.

### (Step S1071)

The image quality condition specification unit 13 sets image quality conditions and preferential order of the image quality conditions when a good image is separated. Thereafter, the image quality determination unit 18 executes the process of steps S1072 to S1074 based on the image quality conditions and the preferential order of the image quality conditions set by the image quality condition specification unit 13.

Hereinafter, a description will be given of an example in which an image quality condition of preference 1 is “Image Compression Rate 80% or Higher” and an image quality condition of preference 2 is “Resolution 3264×2448 or Higher” as the image quality conditions and the preferential order of the image quality conditions set by the image quality condition specification unit 13.

In this case, the image quality determination unit 18 first sets a value indicating order of good image data for the image data based on “Image Compression Rate 80% or Higher” that is the image quality condition of preference 1 (steps S1072 and S1074). Subsequently, the image quality determination unit 18 sets the value indicating the order of good image data for the image data based on “Resolution 3264×2448 or Higher” that is the image quality condition of preference 1 (steps S1073 and S1074). That is, the image quality determination unit 18 performs the process in the order of Step S1072→Step S1074→Step S1073→Step S1074.

### (Step S1072)

The image quality determination unit 18 reads information indicating a compression rate of an image included in Exif of the image data from each of the image data stored by the image data storage unit 10 in the process of step S105. Thereafter, it proceeds to the process of step S1074.

### (Step S1074)

Based on the information indicating the compression rate of the image read in the process of step S1072, the image quality determination unit 18 sets a value of a seventh high-order digit within the value indicating the order of good image data to “1” for image data of “Image Compression Rate 80% or Higher” among the image data stored by the image data storage unit 10 in the process of step S105, and sets the value of the seventh high-order digit within the value indicating the order of good image data to “2” for the other image data. Thereafter, it proceeds to the process of step S1073.

### (Step S1073)

The image quality determination unit 18 reads information indicating resolution of the image included in Exif of the image data from each of the image data stored by the image data storage unit 10 in the process of step S105. Thereafter, it proceeds to the process of step S1074.

### (Step S1074)

Based on the information indicating the resolution of the image read in the process of step S1073, the image quality determination unit 18 sets a value of an eighth high-order digit within the value indicating the order of good image data to “1” for image data of “Resolution 3264×2448 or Higher” among the image data stored by the image data storage unit 10 in the process of step S105, and sets the value of the eighth high-order digit within the value indicating the order of good image data to “2” for the other image data. Thereafter, it proceeds to the process of step S108 shown in FIG. 2.

The image processing apparatus 1 can extract image data captured from substantially the same location at substantially the same time in substantially the same composition from among a plurality of image data captured by a plurality of image pickup devices by performing the above-described process of steps S101 to S105. In addition, the image processing apparatus 1 can set a value indicating order of good image data (can set a sequence number) for image data, captured from substantially the same location at substantially the same time in substantially the same composition, extracted in the process of steps S101 to S105 by performing the process of step S106 (steps S1061 to S1068) and step S107 (steps S1071 to S1074). That is, it is possible to separate good image data. In the above-described example, the smaller the value (sequence number) indicating the order of good image data, the better the image data.

According to the first preferred embodiment, the image processing apparatus 1 can extract image data captured from substantially the same location at substantially the same time in substantially the same composition from among image data captured by the plurality of image pickup devices, and separate good image data among the extracted image data.

In addition, the image processing apparatus 1 can extract image data captured from substantially the same location at substantially the same time in substantially the same composition from among image data captured by the plurality of image pickup devices, re-order the extracted image data in order of good image data, and display the re-ordered image data on the display unit 19. Accordingly, the user can easily acquire good image data.

While preferred embodiments of the present invention have been described and illustrated above, it should be understood that these are examples of the present invention and are not to be considered as limiting. Additions, omissions, substitutions, and other modifications can be made without departing from the scope of the present invention.

For example, although an example in which a manufacturer name and a model name of an image pickup device capturing an image, ISO sensitivity of the image, an exposure correction amount of the image, a shutter speed when the image has been captured, an open F value of a lens used when the image has been captured, and a photographer capturing the image are used as image capturing conditions has been described in the first preferred embodiment, the present invention is not limited thereto. For example, image capturing conditions other than the above-described image capturing conditions may be used, and the number of image capturing conditions to be used may be changed.

In addition, although an example in which a compression rate of an image and resolution of the image are used as image quality conditions has been described in the first preferred embodiment, the present invention is not limited thereto. For example, image quality conditions other than the above-described image quality conditions may be used, and the number of image quality conditions to be used may be changed.

In addition, although an example in which a value indicating order of good image data is set based on image quality conditions and preferential order of the image quality conditions after the value indicating the order of good image data is set based on image capturing conditions and preferential order of the image capturing conditions has been described in the first preferred embodiment, the present invention is not limited thereto. For example, the value indicating the order of good image data may be set based on the image capturing conditions and the preferential order of the image capturing conditions after the value indicating the order of good image data is set based on the image quality conditions and the preferential order of the image quality conditions. In addition, image capturing conditions and preferential order of the image capturing conditions may be set commonly, and the value indicating the order of good image data may be set based on the image capturing conditions, image quality conditions, and image capturing conditions and preferential order of the image capturing conditions that are commonly set.

In addition, although an example in which the better the image data, the smaller the value indicating the order of good image data has been described in the first preferred embodiment, the present invention is not limited thereto. Any value for determining the order of good image data may be used. For example, the value may be large when the image data is good.

In addition, although an example in which image data captured at substantially the same time is first extracted, image data captured in substantially the same location is subsequently extracted, and image data captured in substantially the same composition is subsequently extracted when image data captured from substantially the same location at substantially the same time in substantially the same composition is extracted has been described in the first preferred embodiment, the present invention is not limited thereto. The image data may be extracted in any order.

Accordingly, the present invention is not to be considered as being limited by the foregoing description, and is only limited by the scope of the claims.

What is claimed is:

1. An image processing apparatus comprising:
a condition setting unit that sets a specified image capturing time, a specified image capturing location, and specified image capturing composition;
an image capturing time determination unit that extracts image data that has been captured at the specified image capturing time, which has been set by the condition setting unit, from among a plurality of image data based on additional information included in the image data;
an image capturing location determination unit that extracts the image data that has been captured in the specified image capturing location, which has been set by the condition setting unit, from among the plurality of image data based on the additional information;
a composition determination unit that extracts the image data that has been captured in the specified image capturing composition, which has been set by the condition setting unit, from among the plurality of image data based on the additional information; and
an order setting unit that generates information indicating order of the image data consistent with given conditions based on the additional information for the image data that has been extracted by all of the image capturing time determination unit, the image capturing location determination unit, and the composition determination unit.

2. The image processing apparatus according to claim 1, wherein the condition setting unit:
reads, from one specified image data, information indicating an image capturing time of the image data, information indicating an image capturing location of the image data, and information indicating image capturing composition of the image data;
sets the image capturing time indicated by the information indicating the image capturing time to the specified image capturing time;
sets the image capturing location indicated by the information indicating the image capturing location to the specified image capturing location; and
sets the image capturing composition indicated by the information indicating the image capturing composition to the specified image capturing composition.

3. The image processing apparatus according to claim 1, wherein the condition setting unit:
sets an image capturing time set by a user to the specified image capturing time;
sets an image capturing location set by the user to the specified image capturing location; and
sets image capturing composition set by the user to the specified image capturing composition.

4. The image processing apparatus according to claim 1, wherein
the additional information is stored in an exchangeable image file format,
the additional information comprising:
information indicating a time when an image has been captured;
information indicating a location where the image has been captured; and
information indicating image capturing composition of the image that includes:
information indicating a direction of the image;
information indicating a length to a subject included in the image; and
information indicating a focal length of a lens used when the image has been captured.

5. The image processing apparatus according to claim 1, wherein the given conditions are specified by at least one of image capturing condition information and image quality condition information.

6. The image processing apparatus according to claim 5, wherein the image capturing condition information indicates at least one of International Organization for Standardization (ISO) sensitivity, an exposure correction amount, a shutter speed, and an open F value of the image data.

7. The image processing apparatus according to claim 5, wherein the image quality condition information indicates at least one of an image compression rate and resolution of the image data.
